(19) United States
(12) Patent Application Publication
(10) Pub. No.: US 2009/0231761 A1
(43) Pub. Date: Sep. 17, 2009

(54) HEAD SUSPENSION ASSEMBLY AND STORAGE DEVICE

(75) Inventor: Kaoru Abiko, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/246,954

(22) Filed: Oct. 7, 2008

(30) Foreign Application Priority Data
Mar. 17, 2008 (JP) 2008-67982

(51) Int. Cl. G11B 5/56

(52) U.S. Cl. 360/290

(57) ABSTRACT

A head suspension assembly includes a head suspension, a load beam having a protrusion, a flexure attached to a surface of the head suspension at a back surface of the flexure and a support plate defined on the flexure. A head slider is secured to the support plate. The support plate and head slider are secured to the load beam over the protrusion. The support plate extends outward from a contour of the head slider, and has at least two openings corresponding to desired locations of corners of the head slider, and a window formed in the head suspension behind the flexure, so that the head slider can be accurately aligned with respect to the openings when the head slider is adhered to the support plate.

### BACKGROUND OF THE INVENTION

1. Field of the Invention

The embodiments discussed herein are directed to a head suspension assembly incorporated in a storage device such as a hard disk drive (HDD).

2. Description of the Related Art

Head suspension assemblies are widely known as disclosed in Patent Document (Japanese Patent Laid-Open No. 2001-143422, Japanese Patent Laid-Open No. 06-203508, Japanese Patent Laid-Open No. 2004-213820), for example. In such a head suspension assembly, a flexure is attached to a head suspension. A head slider is mounted on a gimbal of the flexure. The contour of the head slider is defined to be larger than the contour of the gimbal. The gimbal is received on a protrusion of the head suspension so as to freely change its attitude.

If the head slider is positioned with high accuracy with respect to the protrusion, the attitude change of the head slider is stably established. The contour of the head slider is defined to be larger than the contour of the gimbal as described above. As a result, the position of the head slider with respect to the gimbal can be easily identified from behind the gimbal, for example. However, since the gimbal has a small surface area, the head slider cannot be bonded to the gimbal with sufficient strength.

A head suspension assembly and a storage device according to a present embodiment have been made in view of the aforementioned circumstances, and an object thereof is to provide a head suspension assembly and a storage device capable of positioning a head slider with high accuracy by ensuring high bonding strength with respect to a flexure such as a gimbal.

### SUMMARY

In accordance with an aspect of embodiments, a head suspension assembly includes a head suspension, a protrusion defined on the head suspension, and a flexure attached to the head suspension. A support plate defined on the flexure is received on the protrusion so as to freely change its attitude and a head slider is bonded to the support plate. The support plate has a contour extending around a contour of the head slider. At least two openings are formed in the support plate, and the head slider is located within a contour defined by the openings. A window is formed in the head suspension behind the flexure. The openings are located within a contour of the window, so the openings can be seen when the head slider is adhered to the support plate. In this manner, the head slider is accurately located in the head suspension assembly.

### BRIEF DESCRIPTION OF THE DRAWINGS

FIG. 1 is a plan view schematically illustrating the inner structure of a hard disk drive (HDD) as an example of a storage device according to the present invention.

FIG. 2 is a plan view schematically illustrating the structure of a head suspension assembly according to a first embodiment of the present invention.

FIG. 3 is an enlarged partial plan view schematically illustrating the structure of the head suspension assembly according to the first embodiment of the present invention.

FIG. 4 is a partial sectional view schematically illustrating the structure of the head suspension assembly according to the first embodiment of the present invention.

FIG. 5 is an enlarged partial rear view schematically illustrating the structure of the head suspension assembly according to the first embodiment of the present invention.

FIG. 6 is an enlarged partial rear view schematically illustrating the structure of a head suspension assembly according to a second embodiment of the present invention.

### DETAILED DESCRIPTION OF THE EMBODIMENTS

In the following, an embodiment of the present invention will be described with reference to the accompanying drawings.

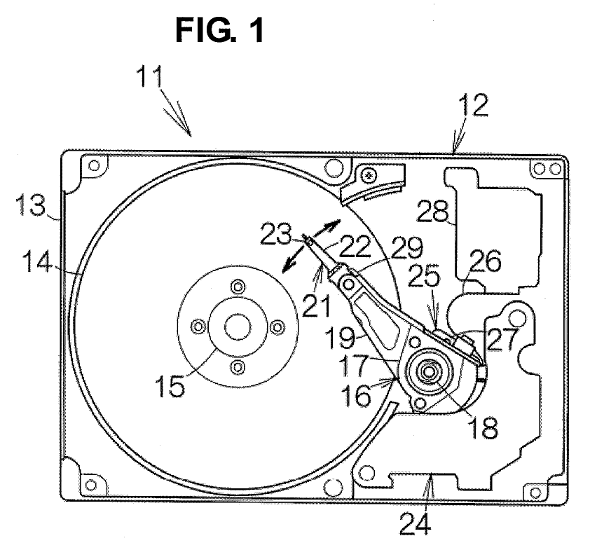

FIG. 1 schematically illustrates the inner structure of a hard disk drive (HDD) 11 as an example of a storage device according to the present invention. The HDD 11 includes an enclosure, namely, a housing 12. The housing 12 includes a box-shaped base 13 and a cover (not shown). The base 13 defines an inner space, namely, an accommodating space, in the form of a flat parallelepiped, for example. The base 13 may be made of a metallic material such as aluminum, for example. Molding process may be employed to form the base 13. The cover is coupled to the opening of the base 13. The accommodating space is sealed between the cover and the base 13. Pressing process may be employed to form the cover out of a single plate material, for example.

One or more magnetic disks 14 as a storage medium are accommodated in the accommodating space. The magnetic disks 14 are mounted on the rotating shaft of a spindle motor 15. The spindle motor 15 can rotate the magnetic disks 14 at a high speed such as 5400 rpm, 7200 rpm, 10000 rpm, 15000 rpm or the like.

A carriage 16 is also accommodated in the accommodating space. The carriage 16 includes a carriage block 17. The carriage block 17 is rotatably coupled to a support shaft 18 extending in the vertical direction. A plurality of carriage arms 19 extending in the horizontal direction from the support shaft 18 are defined in the carriage block 17. The carriage block 17 may be made of aluminum, for example. Extrusion molding process may be employed to form the carriage block 17, for example.

A head suspension assembly 21 is attached to the tip end of the individual carriage arm 19. A caulking technique may be used for the attachment, for example. A hole defined in the tip end of the carriage arm 19 may be aligned with a hole defined in the rear end of the head suspension assembly 21 for the caulking.

The head suspension assembly 21 includes a head suspension 22. The head suspension 22 extends forward from the tip end of the carriage arm 19. A flying head slider 23 is supported on the front end of the head suspension 22. A head element, namely, an electromagnetic transducer is mounted on the flying head slider 23.

An airflow is generated on the surface of the magnetic disk 14 based on the rotation of the magnetic disk 14. The airflow serves to cause a positive pressure, namely, a lift, and a negative pressure to be exerted on the flying head slider 23. The combination of the lift and the negative pressure is balanced with the urging force of the head suspension 22. The flying head slider 23 is thereby allowed to keep flying during the rotation of the magnetic disk 14 with relatively high stability.

When the carriage 16 swings around the support shaft 18 during the flight of the flying head slider 23, the flying head slider 23 is allowed to move along the radial line of the magnetic disk 14. Accordingly, the electromagnetic transducer on the flying head slider 23 is allowed to cross the data zone between the innermost recording track and the outermost recording track. The electromagnetic transducer on the flying head slider 23 can be thereby positioned above a target recording track.

A power source such as a voice coil motor (VCM) 24 is connected to the carriage block 17. The VCM 24 serves to rotate the carriage block 17 around the support shaft 18. The carriage arm 19 and the head suspension 22 are allowed to swing based on the rotation of the carriage block 17.

As seen in FIG. 1, a flexible printed circuit board unit 25 is located on the carriage block 17. The flexible printed circuit board unit 25 includes a head IC (integrated circuit) 27 mounted on a flexible printed circuit board 26. The head IC 27 supplies a sensing current to a read element of the electromagnetic transducer at the time of reading magnetic information. Similarly, the head IC 27 supplies a writing current to a write element of the electromagnetic transducer at the time of writing magnetic information.

A small-sized circuit board 28 located within the accommodating space and a printed circuit board (not shown) attached to the back of the bottom plate of the base 13 supply the sensing current and the writing current to the head IC 27. A relay flexible printed circuit board 29 is used for the supply of the sensing current and the writing current, for example. The flexible printed circuit board 29 has a wiring pattern thereon. The flexible printed circuit board 29 is connected to the flexible printed circuit board unit 25.

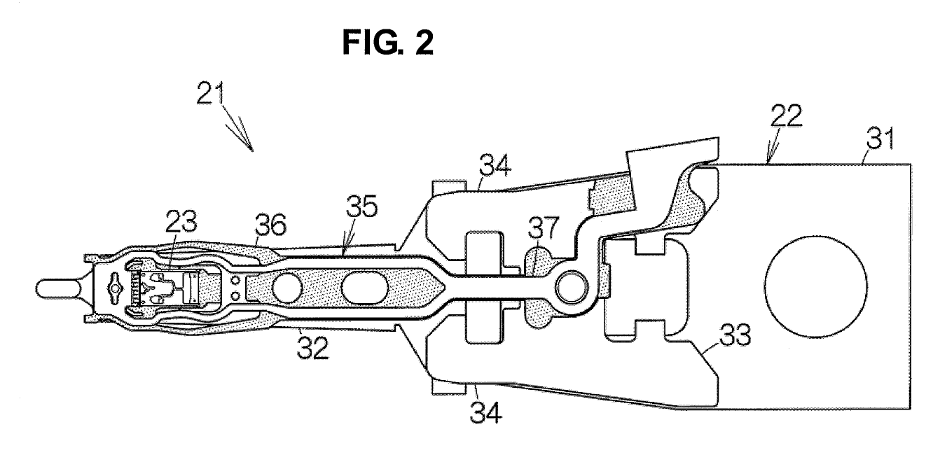

FIG. 2 schematically illustrates the structure of the head suspension assembly 21 according to the first embodiment of the present invention. The head suspension assembly 21 includes a base plate 31 attached to the tip end of the carriage arm 19 and a load beam 32 distanced forward from the base plate 31 at a predetermined interval. Caulking process is employed to fix the base plate 31 to the carriage arm 19, for example.

A hinge plate 33 is bonded to the surfaces of the base plate 31 and the load beam 32. The hinge plate 33 may be bonded by performing spot welding at a plurality of bonding spots, for example. A YAG laser is used in the spot welding, for example. The hinge plate 33 includes an elastic bending section 34 between the front end of the base plate 31 and the rear end of the load beam 32. The hinge plate 33 thereby couples the base plate 31 and the load beam 32. The base plate 31, the load beam 32 and the hinge plate 33 constitute the head suspension 22.

A flexure 35 is attached to the surface of the head suspension 22. The flexure 35 includes a stainless steel plate 36 bonded to the surface of the head suspension 22. The stainless steel plate 36 has a thickness of about 20 μm, for example. The stainless steel plate 36 may be bonded by performing spot welding at a plurality of bonding spots, for example. A YAG laser is used in the spot welding, for example. The stainless steel plate 36 extends backward from the tip end of the head suspension 22. The stainless steel plate 36 extends outward from the contour of the base plate 31. A wiring pattern 37 is formed on the surface of the stainless steel plate 36. The wiring pattern 37 electrically connects the flying head slider 23 and the flexible printed circuit board 29. The flying head slider 23 is connected to the flexible printed circuit board unit 25 in this manner.

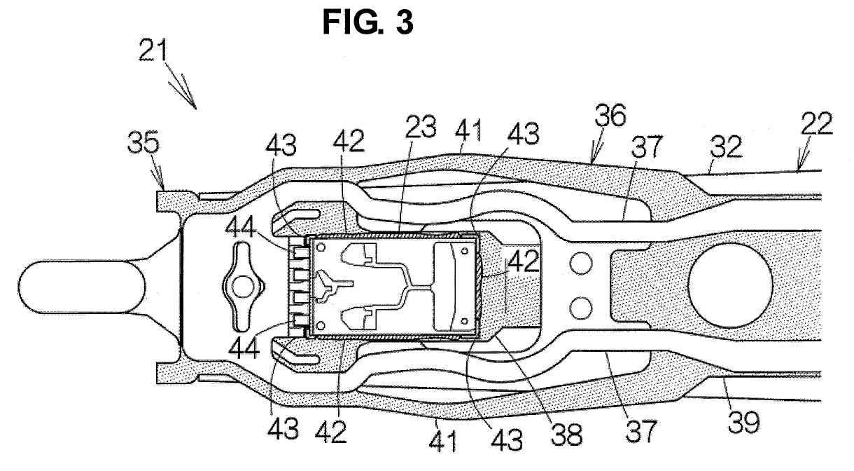

As shown in FIG. 3, the stainless steel plate 36 includes a support plate 38 for receiving the flying head slider 23 at the surface and a fixation plate 39 fixed to surfaces of the load beam 32 and the hinge plate 33 (FIG. 2). A so-called gimbal spring 41 is defined between the support plate 38 and the fixation plate 39. The gimbal spring 41 extends in parallel along the side edges of the support plate 38 both sides of the support plate 38. The gimbal spring 41 allows the support plate 38, namely, the flying head slider 23 to change its attitude relative to the fixation plate 39.

The support plate 38 extends around and outside the contour of the flying head slider 23. An adhesive 42 may be employed to bond the flying head slider 23 to the surface of the support plate 38. The adhesive 42 is spread on the support plate 38 outward from the contour of the flying head slider 23. The wiring pattern 37 includes an insulating layer, an electrically-conductive layer, and a protection layer laminated in sequence on the stainless steel plate 36. The electrically-conductive layer is made of an electrically-conductive material such as copper. The insulating layer and the protection layer are made of a resin material such as polyimide resin. As is clear from FIG. 3, the wiring pattern 37 extends inside the gimbal spring 41. The wiring pattern 37 extends partially outward from the stainless steel plate 36 in this manner.

Openings 43 are formed in the support plate 38 corresponding to the four corners of the contour of the flying head slider 23. Etching process may be employed to form the openings 43, for example. Electrical conductors 44 electrically connect the flying head slider 23 and the flexible printed circuit board 29. Each electrical conductor 44 is formed of a ball bump, for example. The electrical conductors 44 are received on an electrically-conductive pad formed on the end surface on the air outflow side of the flying head slider 23. The electrically-conductive pads are connected to the electromagnetic transducer. Similarly, each electrical conductor 44 is received on an electrically-conductive pad formed on the surface of the stainless steel plate 36. The electrically-conductive pad is connected to the wiring pattern 37.

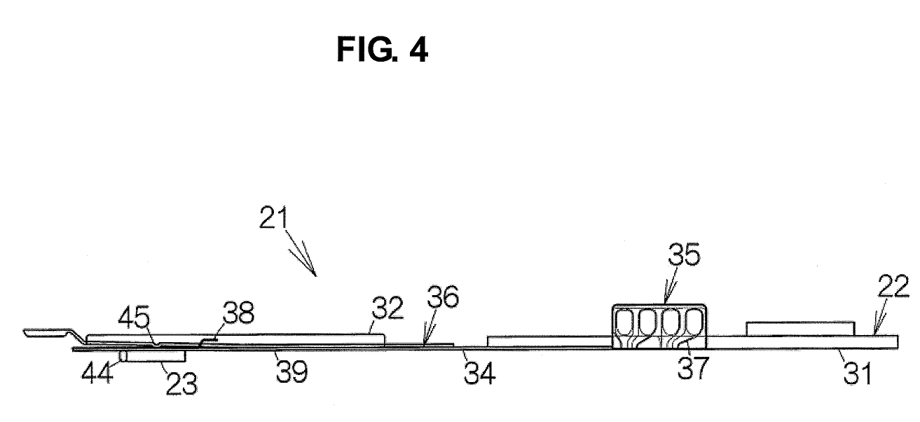

As shown in FIG. 4, the support plate 38 is received on a domed protrusion 45 formed on the surface of the load beam 32 behind the flying head slider 23. The height of the protrusion 45 from the surface of the load beam 32 is set to about 50 μm, for example. Pressing process may be employed to extrude the shape of the protrusion 45 from a metal plate, for example. The protrusion 45 allows a depression to be formed in the back surface of the load beam 32. The depression allows the position of the protrusion 45 to be identified in the back surface of the load beam 32.

The aforementioned elastic bending section 34 exerts a predetermined elastic force, namely, bending force. The bending force serves to impart an urging force toward the surface of the magnetic disk 14 to the front end of the load beam 32. The urging force acts on the flying head slider 23 from behind the support plate 38 through the protrusion 45. The flying head slider 23 is allowed to change its attitude based on the lift generated by the airflow. Hereby, the protrusion 45 does not interfere with the change in the attitude of the flying head slider 23, namely, the support plate 38.

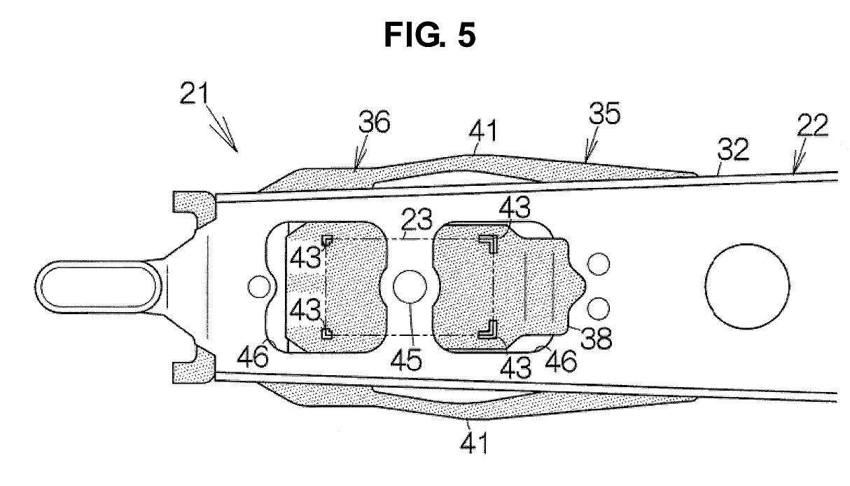

As shown in FIG. 5, a pair of windows 46 and 46 in which the openings 43 are located within the contour thereof is formed in the load beam 32 behind the support plate 38, for example. The aforementioned protrusion 45 is located on the load beam 32 between the windows 46 and 46. The position of the protrusion 45 can be identified by the position of the aforementioned depression. The windows 46 and 46 allow the openings 43 to be observed from behind the flexure 35. The corner of the contour of the flying head slider 23 is located within the contour of each of the openings 43. An area in which the flying head slider 23 is allowed to move is decided according to the size of each of the openings 43. Here, the size of each of the openings 43 may be set based on the assembling accuracy of the head suspension assembly 21, for example.

The base plate 31 and the load beam 32 are coupled by the hinge plate 33 (FIG. 2) in the production of the head suspension assembly 21. The hinge plate 33 may be spot-welded on the surfaces of the base plate 31 and the load beam 32 so as to couple the base plate 31 and the load beam 32. The flexure 35 is attached to the surfaces of the load beam 32 and the hinge plate 33 by spot welding. The heat-curable adhesive 42 is applied to the surface of the support plate 38 of the flexure 35, for example. The adhesive 42 is applied to the inner side of the contour of the flying head slider 23, for example.

The flying head slider 23 is located on the surface of the support plate 38. The flying head slider 23 is supported by a support arm so as to locate the flying head slider 23 on the surface of the support plate 38, for example. The adhesive 42 is pressed and spread between the flying head slider 23 and the support plate 38 at this time. The adhesive 42 is spread outward from the contour of the flying head slider 23 on the surface of the support plate 38. The support arm moves the flying head slider 23 along the surface of the support plate 38. The four corners of the contour of the flying head slider 23 are located within the respective openings 43.

A camera is employed to take an image of the back surface of the flexure 35 from behind the flexure 35, for example. An operator adjusts the corner positions of the contour of the flying head slider 23 within the openings 43 based on the camera image. The center position of the depression of the protrusion 45 is referenced for the adjustment. The relative positions of the center position of the depression of the protrusion 45 and the corner positions of the contour of the flying head slider 23 are thereby adjusted. The relative positions may be set in advance. As a result of such adjustment, the position of the flying head slider 23 with respect to the protrusion 45 is decided. The openings 43 are set based on the assembling accuracy of the head suspension assembly 21. Therefore, the corners of the contour of the flying head slider 23 can be reliably located within the openings 43 even if the relative position of the flexure 35 with respect to the load beam 32 is deviated, for example.

After that, the adhesive 42 is heated to a predetermined temperature. The adhesive 42 is cured. The flying head slider 23 is thereby bonded to the surface of the support plate 38. As described above, the support plate 38 defines the contour extending outward from the contour of the flying head slider 23. The adhesive 42 is pressed and spread outward from the contour of the flying head slider 23 on the support plate 38. As a result, the adhesive 42 is not only sandwiched between the flying head slider 23 and the support plate 38, but can also be spread upward on the side faces of the flying head slider 23, for example. Accordingly, the flying head slider 23 can be bonded to the support plate 38 with high strength.

In the head suspension assembly 21 as described above, the flexure 35, namely, the support plate 38 defines the contour extending outward from the contour of the flying head slider 23. The flying head slider 23 is thereby attached to the support plate 38 over the entire back surface of the plate. Additionally, the adhesive 42 is spread on the support plate 38 outward from the contour of the flying head slider 23. The flying head slider 23 is bonded to the support plate 38 with high bonding strength. Moreover, the openings 43 are located within the windows 46 of the load beam 32 behind the support plate 38. The corners of the contour of the flying head slider 23 are located within the contours of the openings 43. Accordingly, the position of the flying head slider 23 with respect to the position of the protrusion 45 is correctly set with high accuracy. The flying head slider 23 is thus allowed to establish a stable flying attitude.

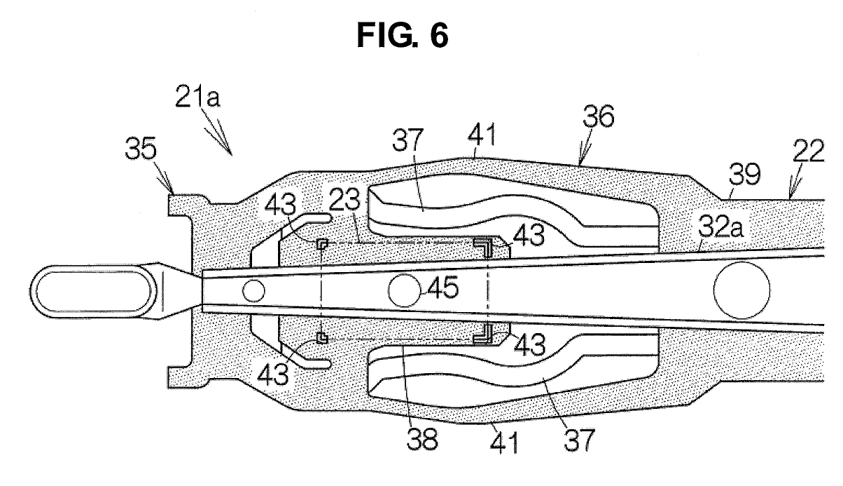

FIG. 6 schematically illustrates the structure of a head suspension assembly 21a according to a second embodiment of the present invention. A load beam 32a, instead of the above load beam 32, is incorporated in the head suspension assembly 21a. The load beam 32a has a width smaller than the distance defined between the two openings 43 on the air outflow end side of the flying head slider 23, and the distance defined between the two openings 43 on the air inflow end side of the flying head slider 23. Here, the load beam 32a is tapered toward the tip end. The openings 43 are thus located outside the contour of the load beam 32a. As a result, the openings 43 can be observed from the back surface of the support plate 38. Other configurations and structures equivalent to those of the aforementioned head suspension assembly 21 are assigned the same reference numerals.

According to the head suspension assembly 21a, as described above, the corner positions of the flying head slider 23 can be adjusted within the openings 43 based on the camera image from behind the flexure 35. The position of the flying head slider 23 with respect to the protrusion 45 is correctly set with high accuracy in this manner. The flying head slider 23 is thus allowed to establish a stable flying attitude. Moreover, the adhesive 42 can be spread on the support plate 38 outward from the contour of the flying head slider 23. The flying head slider 23 can be bonded to the support plate 38 with high bonding strength.

In the HDD 11 as described above, the openings 43 may be individually located with respect to at least any two corners of the contour of the flying head slider 23. Any of the two corners on the air inflow end side of the flying head slider 23 and the two corners on the air outflow end side of the flying head slider 23 may be selected, for example. Similarly, any two corners specified by a diagonal line on the back surface of the flying head slider 23 laminated on the surface of the support plate 38 may be selected, for example. When at least any two corners are respectively located within the openings 43, the position of the flying head slider 23 can be identified from the back surface of the support plate 38. The openings 43 may also be individually located with respect to three corners of the contour of the flying head slider 23.

As described above, according to the head suspension assembly and the storage device of the present embodiments, the head suspension assembly and the storage device capable of positioning the head slider with high accuracy by ensuring high bonding strength with respect to the flexure can be provided.

In addition to variations and modifications in the component parts and/or arrangements, alternative uses will also be apparent to those skilled in the art.

What is claimed is:

1. A head suspension assembly comprising:
a head suspension;
a protrusion defined on the head suspension;
a flexure attached to a surface of the head suspension at a back surface of the flexure;
a support plate defined on the flexure and received on the protrusion so as to freely change its attitude, and
a head slider secured to the support plate, the support plate extending outward from a contour of the head slider;
at least two openings formed in the support plate the contour of the head slider being located within a contour of the openings; and
a window formed in the head suspension behind the flexure, the openings being located within a contour of the window so that the head slider can be accurately aligned when the head slider is secured to the support plate.

2. The head suspension assembly according to claim 1, wherein the head slider is secured to the support plate using an adhesive, and the adhesive is spread on the support plate outward from the contour of the head slider.

3. A head suspension assembly comprising:
a head suspension;
a protrusion defined on the head suspension;
a flexure attached to a surface of the head suspension at a back surface of the flexure;
a support plate defined on the flexure and received on the protrusion so as to freely change its attitude, and
a head slider secured to the support plate, the support plate extending outward from a contour of the head slider; and
at least two openings formed in the support plate the head slider being located within a contour of the openings, wherein
the openings are located outside a contour of the head slider behind the flexure so that the head slider can be accurately aligned when the head slider is secured to the support plate.

4. The head suspension assembly according to claim 3, wherein the head slider is secured to the support plate using an adhesive, and the adhesive is spread on the support plate outward from the contour of the head slider.

5. A storage device comprising:
a storage medium;
a head slider adapted to face a surface of the storage medium;
a head suspension;
a protrusion defined on the head suspension;
a flexure attached to a surface of the head suspension at a back surface of the flexure;
a support plate defined on the flexure and received on the protrusion so as to freely change its attitude,
the head slider being secured to the support plate, the support plate defining a contour outside a contour of the head slider;
at least two openings formed in the support plate, the head slider being located within a contour of the openings; and
a window formed in the head suspension behind the flexure, the openings being located within a contour of the window so that the head slider can be accurately aligned when the head slider is secured to the support plate.

6. A storage device comprising:
a storage medium;
a head slider adapted to face a surface of the storage medium;
a head suspension;
a protrusion defined on the head suspension;
a flexure attached to a surface of the head suspension at a back surface of the flexure;
a support plate defined on the flexure and received on the protrusion so as to freely change its attitude,
the head slider being secured to the support plate, the support plate defining a contour outside a contour of the head slider; and
at least two openings formed in the support plate, the head slider being located within a contour of each of the openings, wherein
the openings are located outside a contour of the head slider behind the flexure so that the head slider can be accurately aligned when the head slider is secured to the support plate.
